(19) United States
(12) Patent Application Publication
(10) Pub. No.: US 2025/0363395 A1
(43) Pub. Date: Nov. 27, 2025

(54) LOGICAL FORMULA GENERATION APPARATUS, LOGICAL FORMULA GENERATION METHOD, AND PROGRAM

(71) Applicant: NEC Corporation, Minato-ku, Tokyo (JP)

(72) Inventor: Kazeto YAMAMOTO, Tokyo (JP)

(73) Assignee: NEC Corporation, Minato-ku, Tokyo (JP)

(21) Appl. No.: 18/873,355

(22) PCT Filed: Jul. 7, 2022
(86) PCT No.: PCT/JP2022/027017

§ 371 Date: Dec. 10, 2024

(51) Int. Cl. G06N 5/04

(52) U.S. Cl. CPC G06N 5/04

(57) ABSTRACT

A logical formula generation apparatus of the present invention includes: a planning means for generating a logical transformation protocol for transforming background knowledge information and input information into logical formulas based on the background knowledge information, the input information, a reasoning schema and a conceptual schema, the background knowledge information representing a reasoning rule, the input information being subjected to a reasoning process by the reasoning rule, the reasoning schema representing a reasoning mode in the reasoning process, the conceptual schema representing a concept handled in the reasoning process; and a transforming means for transforming the background knowledge information and the input information into logical formulas based on the generated logical transformation protocol.

### TECHNICAL FIELD

The present invention relates to a logical formula generation apparatus, a logical formula generation method, and a program.

### BACKGROUND ART

Deduction, or deductive reasoning is a reasoning mode by which a logical formula (proposition) representing proposition information as input information and a logical formula (background knowledge) representing a reasoning rule are received and a logical formula (consequence) derived by the reasoning rule from the input information is output.

Abduction, or abductive reasoning is a reasoning mode by which a logical formula (observation) representing observation information as input information and background) knowledge are received and a logical formula (hypothesis) deriving the input information by a reasoning rule as consequence is output.

Although deductive reasoning and abductive reasoning are theoretically different logical reasoning modes, they are the same in receiving input information and a reasoning rule and outputting a reasoning result, and can be interpreted as essentially the same when implemented on a computer. Therefore, models based on deductive reasoning or abductive reasoning are collectively referred to as logical reasoning models, and a software program that implements computational processing by the logical reasoning model on a computer is referred to as a logical reasoning engine.

Non-Patent Literature 1 discloses a method for implementing weighted abduction, which is one type of abductive reasoning, on a computer. Non-Patent Literature 2 discloses a method for implementing Markov Logic Network, which is one type of deductive reasoning, on a computer.

### CITATION LIST

### Non-Patent Literature

Non-Patent Literature 1: Naoya Inoue and Kentaro Inui. ILP-based Reasoning for Weighted Abduction. In Proceedings of AAAI Workshop on Plan, Activity and Intent Recognition, pp. 25-32, August 2011.
Non-Patent Literature 2: Richardson, Matt and Domingos, Pedro (2006). Markov Logic Networks. Machine Learning, 62, 107-136, 2006.

### SUMMARY OF INVENTION

### Technical Problem

Here, a system based on a logical reasoning model needs to be provided with input information and a reasoning rule expressed by logical formulas as input. At this time, knowledge in a target domain (domain knowledge) and appropriate logical representation of input vary with what logical reasoning model it is based on, what logical reasoning engine is to be used, what behavior of reasoning is intended to be realized, and so forth. Therefore, for constructing a practical application system based on a logical reasoning model, it is essential that a consideration work is carried out by personnel with in-depth knowledge of a logical reasoning engine, which poses a major problem regarding costs for constructing a system for practical application.

The above problem can be subdivided into several issues. First, the work requires personnel with deep knowledge of a logical reasoning engine to spend a long time, resulting in high human and therefore economic costs. Secondly, in a case where a logical representation for a specific state is modified during the abovementioned consideration work, it becomes necessary to manually modify all the corresponding representations contained in the background knowledge information and the input information, which unnecessarily increases the time cost of the consideration work. In other words, if knowledge and information are held in logical representations, it is not possible to automatically rewrite the logical representations used there, because it is not obvious to distinguish which structure arises from a semantic requirement, which structure arises from a requirement for computational efficiency, and which structure arises from a requirement related to the behavior of reasoning. Thus, there has been a problem that it requires man-hours to construct and maintain a logical reasoning system.

Accordingly, an object of the present disclosure is to solve the abovementioned problem that it requires man-hours to construct and maintain a logical reasoning system.

### Solution to Problem

A logical formula generation apparatus as an aspect of the present disclosure includes: a planning means for generating a logical transformation protocol for transforming background knowledge information and input information into logical formulas based on the background knowledge information, the input information, a reasoning schema and a conceptual schema, the background knowledge information representing a reasoning rule, the input information being subjected to a reasoning process by the reasoning rule, the reasoning schema representing a reasoning mode in the reasoning process, the conceptual schema representing a concept handled in the reasoning process; and a transforming means for transforming the background knowledge information and the input information into logical formulas based on the generated logical transformation protocol.

Further, a logical formula generation method as an aspect of the present disclosure includes: generating a logical transformation protocol for transforming background knowledge information and input information into logical formulas based on the background knowledge information, the input information, a reasoning schema and a conceptual schema, the background knowledge information representing a reasoning rule, the input information being subjected to a reasoning process by the reasoning rule, the reasoning schema representing a reasoning mode in the reasoning process, the conceptual schema representing a concept handled in the reasoning process; and transforming the background knowledge information and the input information into logical formulas based on the generated logical transformation protocol.

Further, a program as an aspect of the present disclosure includes instructions for causing a computer to execute processes to: generate a logical transformation protocol for transforming background knowledge information and input information into logical formulas based on the background knowledge information, the input information, a reasoning schema and a conceptual schema, the background knowledge information representing a reasoning rule, the input information being subjected to a reasoning process by the reasoning rule, the reasoning schema representing a reasoning mode in the reasoning process, the conceptual schema representing a concept handled in the reasoning process; and transform the background knowledge information and the input information into logical formulas based on the generated logical transformation protocol.

### Advantageous Effects of Invention

Configured as described above, the present disclosure enables reduction of man-hours for construction and maintenance of a logical reasoning system.

### BRIEF DESCRIPTION OF DRAWINGS

FIG. 1 is a block diagram showing the configuration of a logical formula generation apparatus in a first example embodiment of the present disclosure.

FIG. 2 is a flowchart showing the operation of the logical formula generation apparatus disclosed in FIG. 1.

FIG. 3 is a block diagram showing the configuration of a logical formula generation apparatus in a second example embodiment of the present disclosure.

FIG. 4 is a flowchart showing the operation of the logical formula generation apparatus disclosed in FIG. 3.

FIG. 5 is a block diagram showing the hardware configuration of a logical formula generation apparatus in a third example embodiment of the present disclosure.

FIG. 6 is a block diagram showing the configuration of the logical formula generation apparatus in the third example embodiment of the present disclosure.

### DESCRIPTION OF EXAMPLE EMBODIMENTS

### First Example Embodiment

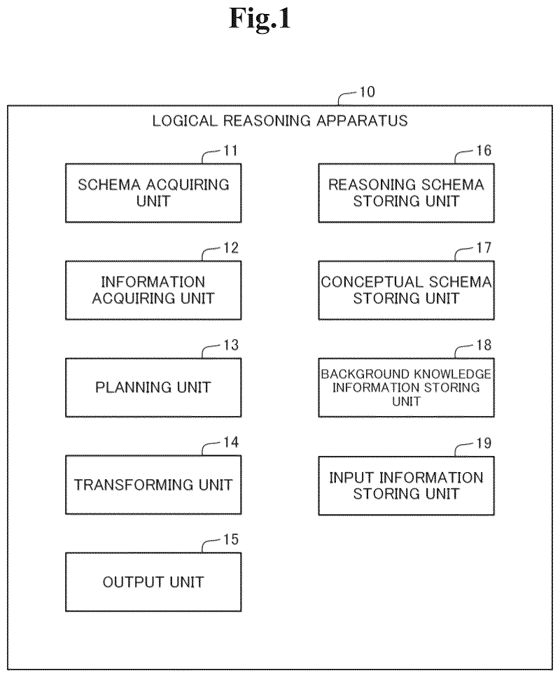

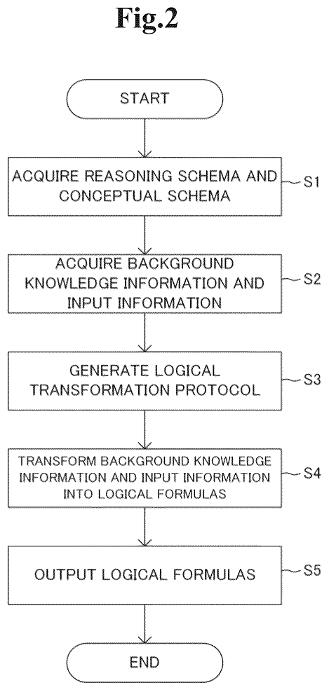

A first example embodiment of the present disclosure will be described with reference to FIGS. 1 and 2. FIG. 1 is a view for describing the configuration of a logical formula generation apparatus, and FIG. 2 is a view for describing the processing operation of the logical formula generation apparatus.

A logical formula generation apparatus 10 in this example embodiment is an apparatus that, for a schema defining a reasoning mode expected to be realized in a target domain and a reasoning rule and input information described based on some description format that is not a logical formula, transforms the reasoning rule and the input information into logical formulas so as to satisfy the expected reasoning mode and outputs the logical formulas. The configuration and operation of the logical formula generation apparatus will be described below.

The logical formula generation apparatus 10 is configured with one or a plurality of information processing apparatuses each including an arithmetic logic unit and a memory unit. Then, as shown in FIG. 1, the logical formula generation apparatus 10 includes a schema acquiring unit 11, an information acquiring unit 12, a planning unit 13, a transforming unit 14, and an output unit 15. The respective functions of the schema acquiring unit 11, the information acquiring unit 12, the planning unit 13, the transforming unit 14, and the output unit 15 can be realized by the arithmetic logic unit executing a program for realizing the respective functions that is stored in the memory unit. The logical formula generation apparatus 10 also includes a reasoning schema storing unit 16, a conceptual schema storing unit 17, a background knowledge information storing unit 18, and an input information storing unit 19. The reasoning schema storing unit 16, the conceptual schema storing unit 17, the background knowledge information storing unit 18, and the input information storing unit 19 are configured with the memory unit.

The schema acquiring unit 11 acquires a reasoning schema that represents the definition of a reasoning mode expected to be realized from the reasoning schema storing unit 16 (step S1). The reasoning schema is information that describes in some format the definition of a reasoning mode that the user wants to realize. The definition of the reasoning mode includes information such as “what logical reasoning model it is based on” and “what logical reasoning engine it uses”. Moreover, information on the content of the reasoning expected to be realized described in the reasoning schema includes the following information using “concept” to be described later. For example, the information includes constraints imposed on the respective concepts in the reasoning mode, such as “a certain concept is always included in observation information”, “a certain concept is never included in observation information”, and “only one logical formula based on a certain concept is always included in a hypothesis”. As an example, in a medical task, it is information that is expected to be obtained as output by the reasoning mode, such as “it is desired to predict whether a specific symptom is present” and “it is desired to derive the most appropriate combination of pathological conditions for observation information”. In addition, the reasoning schema may be described in some text format intended for human writing, or may be described as binary information intended for computer management.

Further, the schema acquiring unit 11 acquires from the conceptual schema storing unit 17 a conceptual schema that represents the definitions of concepts wanted to be treated as components of the reasoning rule and the input information in the reasoning mode expected to be realized (step S1). The conceptual schema is information that describes, in some format, the definitions of concepts that the user wants to treat as components of the reasoning rule and the input information in the reasoning mode that the user wants to realize. The definition of a concept includes information necessary to represent the concept as a logical formula, such as the name and components of the concept. For example, “information for representing a concept as a logical formula” in the conceptual schema is mainly composed of two types of information: “components that compose the concept” and “logical characteristic of each of the components”. As a specific example, in a case where a target domain of logical estimation is medical care, the concepts include pneumonia, cancer, and the like. As an example, a concept of “pneumonia” can be defined as follows.
Components that compose “pneumonia” are “affected person”, “severity”, and “symptom”.
Regarding the component “affected person”, the following logical characteristics hold:
   One “pneumonia” always has exactly one “affected person”.
   Different types of “pneumonia” never have the same “affected person”.
Regarding the component “severity”, the following logical characteristics hold.
   “Severity” is expressed with an integer value.
   One “pneumonia” always has exactly one “severity”.
Regarding the component “symptom”, the following logical characteristics hold.
   One “pneumonia” can have any number of “symptoms”.

In addition, it is also possible to have, as the component of a concept, another concept. The conceptual schema may be described in some text format intended for human writing, or may be described as binary information intended for computer management. A text format used to describe the conceptual schema may be an existing ontology description language such as OWL (Ontology Web Language).

The information acquiring unit 12 acquires background knowledge information that expresses a reasoning rule in some formal language from the background knowledge information storing unit 18 (step S2). The background knowledge information is information that expresses a set of reasoning rules (background knowledge) stating that if the antecedent is true, then the consequent is true, in some formal language. As an example, assume the background knowledge information is information stating, “If you have pneumonia with severity level 3, you will develop sepsis”. At this time, assume a concept “sepsis” has only “affected person” as a component. Then, the background knowledge information is expressed by some character string that can be interpreted by an information processing apparatus, such as “Pneumonia 3: $1=>Sepsis: $1”. Herein, for the purpose of representing that the different concepts “pneumonia” and “sepsis” share the same entity as the component “affected person”, a description representing a variable such as $1 is used.

Further, the information acquiring unit 12 acquires input information that expresses an observation fact in some formal language from the input information storing unit 19 (step S2). The input information is information to be subjected to a reasoning process by the reasoning rule. In addition, any formats may be used as the description formats of the background knowledge information and the input information, but it is favorable to use a language in a format based on a concept defined by the conceptual schema, that is, a language in a format having an expression ability to describe the concept. As an example, assume the input information is “pneumonia 3: Taro Yamada: cough”. Assume this represents “affected person=Taro Yamada, severity=3, symptom=cough” of the concept “pneumonia”.

The information acquiring unit 12 may acquire any or all of the background knowledge information and the input information by reading out from the memory unit built in the logical formula generation apparatus, or may acquire by reading out from an external storage device. Moreover, the information acquiring unit 12 may acquire any or all of the background knowledge information and the input information by receiving from another device via a communication unit. In addition, the information acquiring unit 12 may generate any or all of the background knowledge information and the input information in response to a user's input operation performed via any input device such as a mouse or a touch panel, and acquire the generated information.

The planning unit 13 (planning means) generates a logical transformation protocol, which is a method for transforming the background knowledge information and the input information into logical formulas, with reference to the reasoning schema, the conceptual schema, the background knowledge information, and the input information (step S3). The logical transformation protocol is information that describes in any format a method for transforming the background knowledge information and the input information into logical formulas (transformation rule). In generating the logical transformation protocol, the frequency of appearance in the input information and the reasoning rule of each concept contained in the conceptual schema, the logical reasoning engine to be used, the behavior of reasoning expected to be realized and so forth are considered, but any means may be used to generate the logical transformation protocol based on these elements. For example, by preparing pairs of conditions of the reasoning schema, the conceptual schema, the background knowledge information and the input information and transformation rules for transforming the components of the background knowledge information and the input information into logical formulas, an expert system that outputs a logical transformation protocol with each schema and each information as input. Moreover, for example, by mapping structural characteristics of the respective schemas and the respective information onto a vector space, a logical transformation protocol may be determined and generated based on statistical analysis. That is to say, by combining the reasoning schema and the conceptual schema as described above, a logical transformation protocol for logical formulas can be determined. For example, “severity” in the definition of the concept “pneumonia” is defined as “being a numerical value” in the abovementioned conceptual schema, but in a case where the reasoning engine designated in the reasoning schema does not have a function to designate a numerical value as a logical argument, there is a need to formulate a logical expression that satisfies such behavior within the scope of the function of the engine, so that such a logical transformation protocol is created.

The transforming unit 14 (transforming means) transforms the background knowledge information and the input information into logical formulas based on the logical transformation protocol generated by the planning unit 13 (step S4). That is to say, the transforming unit 14 transforms the background knowledge information and the input information into logical formulas using a logical transformation protocol including a transformation rule for transforming the components of the background knowledge information and the input information into logical formulas.

Here, an example of the abovementioned logical transformation protocol and an example of transforming the input information into a logical formula will be given. The logical transformation protocol is basically composed of information stating, “which argument of what logical formula each component of each concept corresponds to”. For example, the following logical transformation protocol is generated for the abovementioned concept of “pneumonia”.
Pneumonia (r, p, x)
   The first argument r is a logical variable for reference that indicates pneumonia itself.
   The second argument p is a logical variable that indicates an affected person.
   The third argument x is a logical variable that represents severity.
   Symptoms for a certain pneumonia r are described as different logical formulas sharing the same variable.
      Example: “pneumonia (R, John, 2)∧cough (R)∧phlegm (R)” represents, “John suffers from pneumonia R, which has symptoms of cough and phlegm”.

Then, as for logical transformation of the input information, a logical formula can be obtained by simply applying a concept described in some format to the above correspondence relation. The procedure is as follows.
(1) Acquire input information “pneumonia 3: Taro Yamada: cough”.
(2) Interpret the character string of the input information as a concept description.
   Interpret as “affected person=Taro Yamada, severity=3, symptom=cough” of the concept “pneumonia”.
(3) Transform into a logical formula using the logical transformation protocol.
   Obtain a logical formula “pneumonia (R1, Taro Yamada, 3)∧cough (R1)”.

Further, an example of the abovementioned logical transformation protocol and an example of transforming the background knowledge information into a logical formula will be given. In this case, a logical transformation protocol is generated as a rule for transforming a content “if the antecedent is true, then the consequent is true” into a logical formula “the antecedent is true=>the consequent is true”. Then, the abovementioned background knowledge information “if a person has pneumonia with severity 3, then the person will develop sepsis” is expressed as a character string that can be interpreted by an information processing apparatus, such as “pneumonia 3: $1=>sepsis: $1”, and the character string is interpreted as a conceptual description, and the following conceptual entity is obtained, for example.
Concept “pneumonia” of component “affected person=$1, severity=3”.
Concept “sepsis” of component “affected person=$1”.
   These conceptual entities are transformed into logical formulas by the logical transformation protocol, and finally, using the abovementioned input information, the following logical formula is obtained a reasoning rule.

Logical formula: pneumonia (r, x1, 3)=>sepsis (x1)

The output unit 15 outputs the logical formulas generated by the transforming unit 14 as the input information and the reasoning rule (step S5). As an example, the output unit 15 may display the logical formulas on a display panel, or may store the logical formulas in a recording medium, which is not shown in the drawings. Moreover, for example, the logical formulas may be output to another device via an input/output interface or a communication interface.

According to the above configuration, the logical formula generation apparatus automatically generates and outputs appropriate logical formulas with respect to the input information and the background knowledge information so as to realize a reasoning mode determined by the reasoning schema and the conceptual schema. Consequently, compared to manually designing and writing the logical expressions of the input information and the background knowledge information, it is possible to increase a human efficiency related to constructing a logical reasoning system and reduce man-hours and also reduce the knowledge and skills required for the work. Moreover, knowledge and information can be held separately from the logical expressions, and an appropriate logical expression can be automatically generated as needed.

### Second Example Embodiment

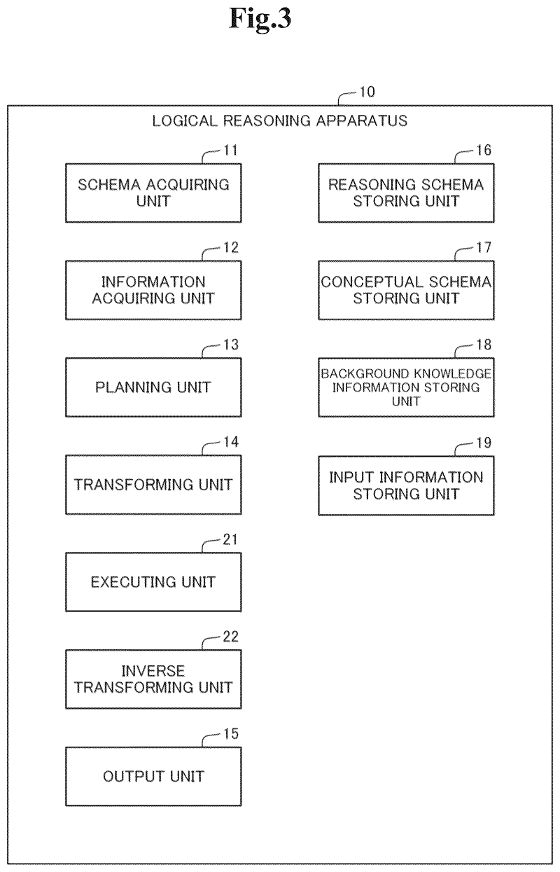

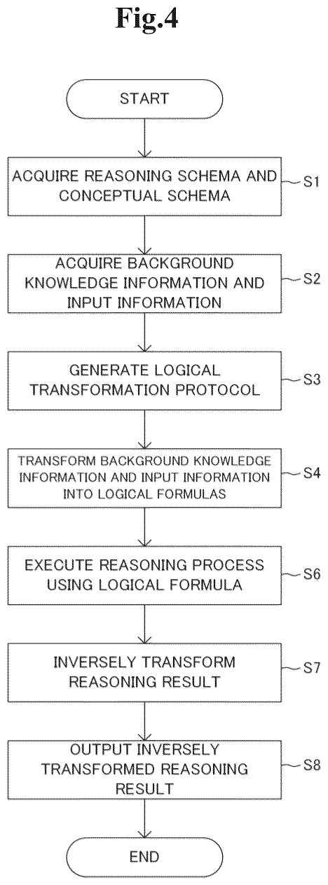

A second example embodiment of the present disclosure will be described with reference to FIGS. 3 and 4. FIG. 3 is a view for describing the configuration of a logical formula generation apparatus, and FIG. 4 is a view for describing the processing operation of the logical formula generation apparatus. Here, a component having the same function as the component described in the first example embodiment will be denoted by the same reference numeral and a description thereof will be omitted as necessary.

As shown in FIG. 3, the logical formula generation apparatus 10 in this example embodiment includes an executing unit 21 and an inverse transforming unit 22 in addition to the configuration of the first example embodiment. The respective functions of the executing unit 19 and the inverse transforming unit 22 can be realized by the arithmetic logic unit executing a program for realizing the respective functions stored in the memory unit.

The executing unit 21 (executing means) obtains the result (reasoning result) of executing logical reasoning by a logical reasoning engine designated by a reasoning schema using, as input, the result of transforming the background knowledge information and the input information generated by the transforming unit 14 described above into logical formulas (step S6). The reasoning result is the result of execution by the logical reasoning engine using, as input, the result of transforming the background knowledge information and the input information into logical formulas, represented by one or more logical formulas.

The inverse transforming unit 22 (inverse transforming means) transforms the reasoning result represented by the logical formula into an expression using vocabulary on the conceptual schema based on the logical transformation protocol obtained by the planning unit 13 described above (step S7). That is to say, the inverse transforming unit 22 transforms the reasoning result represented by the logical formula into an expression using vocabulary on the conceptual schema, by utilizing, for inverse transformation, the correspondence relation between the components of the respective concepts and the arguments of the respective logical formulas representing the transformation rule for transforming the components of the background knowledge information and the input information into logical formulas of the logical transformation protocol. For example, the logical formula “pneumonia (R, John, 2)∧cough (R)∧sputum (R)” is an entity of the concept “pneumonia”, and the components thereof can be inversely transformed into “affected person=John, severity=2, symptoms=cough & sputum”. Moreover, the background knowledge information represented by a logical formula can also be inversely transformed in the same manner. For example, the logical formula “pneumonia (r, x1, 3)=>sepsis (x1)” can be transformed into an expression with the content “pneumonia 3: $1=>sepsis: $1,” that is, “an affected person suffering from pneumonia with severity 3 will develop sepsis”.

The output unit 15 outputs a reasoning result represented using vocabulary on the conceptual schema generated by the inverse transforming unit 22, unlike that of the first example embodiment (step S8). As an example, the output unit 15 may display the reasoning result on a display panel, or may store the reasoning result in a recording medium, which is not shown in the drawings. Moreover, as an example, the output unit 18 may output the reasoning result to another device via an input/output interface or a communication interface.

According to the above configuration, the logical reasoning apparatus automatically generates an appropriate logical expression with respect to input information and background knowledge information based on a reasoning mode determined by a reasoning schema and a conceptual schema, and outputs the result of reasoning for it using vocabulary on the conceptual schema. Consequently, compared to the case of manually designing and writing the logical expressions of the input information and the background knowledge information, it is possible to increase the human efficiency of constructing a logical reasoning system. In addition, because the logical expressions are hidden from input and output, even a person with no background in logical reasoning can construct a logical reasoning system and interpret a system output.

### Third Example Embodiment

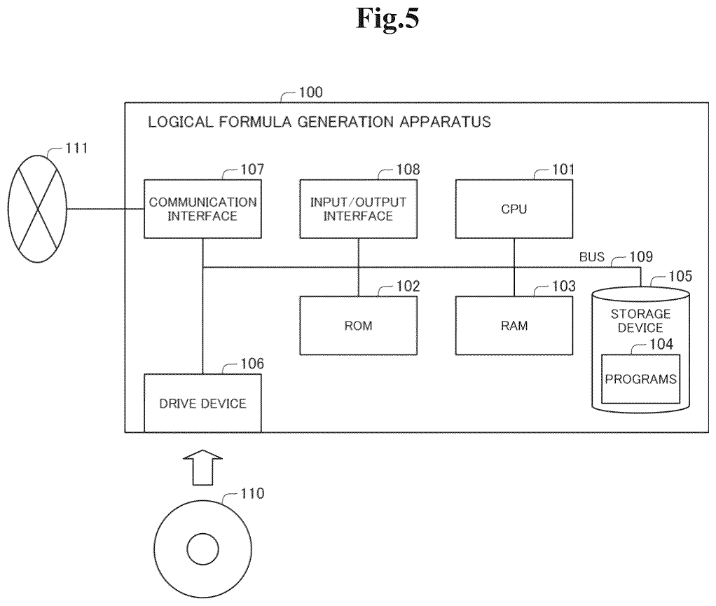

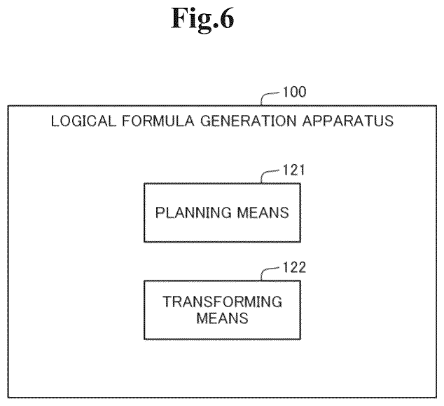

Next, a third example embodiment of the present disclosure will be described with reference to FIGS. 5 and 6. FIGS. 5 and 6 are block diagrams showing the configuration of a logical formula generation apparatus in the third example embodiment. In this example embodiment, the overview of the configuration of the logical formula generation apparatus described in the above example embodiments is shown.

First, the hardware configuration of a logical formula generation apparatus 100 in this example embodiment will be described with reference to FIG. 5. The logical formula generation apparatus 100 is configured with a general information processing apparatus and, as an example, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded to the RAM 103;
a storage device 105 storing the programs;
a drive device 106 that reads from and writes into a storage medium 110 outside the information processing apparatus;
a communication interface 107 connected to a communication network 111 outside the information processing apparatus;
an input/output interface 108 that inputs and outputs data; and
a bus 109 connecting the respective components.

Then, the logical formula generation apparatus 100 can construct and include a planning means 121 and a transforming means 122 shown in FIG. 6 by the CPU 101 acquiring and executing the programs 104. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the planning means 121 and the transforming means 122 mentioned above may be constructed using dedicated electronic circuits for realizing such means.

FIG. 5 shows an example of the hardware configuration of the information processing apparatus serving as the logical formula generation apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller or a combination of these, instead of the abovementioned CPU.

The planning means 121 generates a logical transformation protocol for transforming background knowledge information and input information into logical formulas based on background knowledge information representing reasoning rules, input information to be subjected to a reasoning process by the reasoning rules, a reasoning schema representing a reasoning mode with the reasoning process, and a conceptual schema representing a concept handled in the reasoning process. The reasoning schema is information such as what logical reasoning model it is based on, and what logical reasoning engine is to be used. The concept schema is the definition of concepts that one wants to handle as the components of the reasoning rule and the input information, and includes information necessary to represent the concepts as the logical formulas, such as the names and components of the concepts. Then, the planning means 121 generates a logical transformation protocol by applying a preset transformation rule that corresponds to a condition each schema and each information satisfies.

The transforming means 122 transforms the background knowledge information and the input information into logical formulas based on the generated logical transformation protocol.

With the configuration as described above, the present disclosure enables reduction of man-hours in the construction and maintenance of a logical reasoning system.

The abovementioned programs can be stored using various types of non-transitory computer-readable mediums and provided to a computer. Non-transitory computer-readable mediums include various types of tangible storage mediums. Examples of non-transitory computer-readable mediums include a magnetic recording medium (e.g., flexible disk, magnetic tape, hard disk drive), a magneto-optical recording medium (e.g., magneto-optical disk), a CD-ROM (Read Only Memory), a CD-R, a CD-R/W, and a semiconductor memory (e.g., mask ROM, PROM (Programmable ROM), EPROM (Erasable PROM), flash ROM, RAM (Random Access Memory)). The programs may also be provided to the computer by various types of transitory computer-readable mediums. Examples of transitory computer-readable mediums include electrical signals, optical signals, and electromagnetic waves. Transitory computer-readable mediums can provide the programs to the computer via a wired communication path such as an electric wire or an optical fiber, or via a wireless communication path.

Although the present disclosure has been described above with reference to the above example embodiments, the present disclosure is not limited to the above example embodiments. The configurations and details of the present disclosure can be changed in various manners that can be understood by one skilled in the art within the scope of the present disclosure. Moreover, at least one or more of the functions of the planning means 121 and the transforming means 122 described above may be executed by an information processing apparatus installed and connected anywhere on the network, that is, may be executed by so-called cloud computing.

### SUPPLEMENTARY NOTES

The whole or part of the example embodiments disclosed above can be described as the following supplementary notes. Below, the overview of the configurations of a logical formula generation apparatus, a logical formula generation method, and a program according to the present invention will be described. However, the present invention is not limited to the following configurations.

### Supplementary Note 1

A logical formula generation apparatus comprising:
a planning means for generating a logical transformation protocol for transforming background knowledge information and input information into logical formulas based on the background knowledge information, the input information, a reasoning schema and a conceptual schema, the background knowledge information representing a reasoning rule, the input information being subjected to a reasoning process by the reasoning rule, the reasoning schema representing a reasoning mode in the reasoning process, the conceptual schema representing a concept handled in the reasoning process; and
a transforming means for transforming the background knowledge information and the input information into logical formulas based on the generated logical transformation protocol.

### Supplementary Note 2

The logical formula generation apparatus according to Supplementary Note 1, wherein
the planning means generates the logical transformation protocol that defines a transformation rule for transforming components of the background knowledge information and the input information into logical formulas.

### Supplementary Note 3

The logical formula generation apparatus according to Supplementary Note 2, wherein
the planning means generates the logical transformation protocol that defines the transformation rule corresponding to a condition satisfied by the background knowledge information, the input information, the reasoning schema, and the conceptual schema.

### Supplementary Note 4

The logical formula generation apparatus according to Supplementary Note 1, wherein
the background knowledge information and the input information are described in a language of a format set based on the concept represented by the conceptual schema.

### Supplementary Note 5

The logical formula generation apparatus according to Supplementary Note 1, comprising:
an executing means for executing the logical formula by a reasoning engine based on the reasoning mode represented by the reasoning schema with the logical formula as input for the reasoning engine; and
an inverse transforming means for transforming a reasoning result of a logical formula expression obtained by execution of the logical formula, into an expression corresponding to the concept represented by the conceptual schema based on the logical transformation protocol.

### Supplementary Note 6

A logical formula generation method comprising:
generating a logical transformation protocol for transforming background knowledge information and input information into logical formulas based on the background knowledge information, the input information, a reasoning schema and a conceptual schema, the background knowledge information representing a reasoning rule, the input information being subjected to a reasoning process by the reasoning rule, the reasoning schema representing a reasoning mode in the reasoning process, the conceptual schema representing a concept handled in the reasoning process; and
transforming the background knowledge information and the input information into logical formulas based on the generated logical transformation protocol.

### Supplementary Note 7

The logical formula generation method according to Supplementary Note 6, comprising
generating the logical transformation protocol that defines a transformation rule for transforming components of the background knowledge information and the input information into logical formulas.

### Supplementary Note 8

The logical formula generation method according to Supplementary Note 7, comprising
generating the logical transformation protocol that defines the transformation rule corresponding to a condition satisfied by the background knowledge information, the input information, the reasoning schema, and the conceptual schema.

### Supplementary Note 9

The logical formula generation method according to Supplementary Note 6, wherein
the background knowledge information and the input information are described in a language of a format set based on the concept represented by the conceptual schema.

### Supplementary Note 10

The logical formula generation method according to Supplementary Note 6, comprising:
executing the logical formula by a reasoning engine based on the reasoning mode represented by the reasoning schema with the logical formula as input for the reasoning engine; and
transforming a reasoning result of a logical formula expression obtained by execution of the logical formula, into an expression corresponding to the concept represented by the conceptual schema based on the logical transformation protocol.

### Supplementary Note 11

A non-transitory computer-readable storage medium storing a program comprising instructions for causing a computer to execute processes to:
generate a logical transformation protocol for transforming background knowledge information and input information into logical formulas based on the background knowledge information, the input information, a reasoning schema and a conceptual schema, the background knowledge information representing a reasoning rule, the input information being subjected to a reasoning process by the reasoning rule, the reasoning schema representing a reasoning mode in the reasoning process, the conceptual schema representing a concept handled in the reasoning process; and
transform the background knowledge information and the input information into logical formulas based on the generated logical transformation protocol.

### REFERENCE SIGNS LIST

10 logical formula generation apparatus
11 schema acquiring unit
12 information acquiring unit
13 planning unit
14 transforming unit
15 output unit
16 reasoning schema storing unit
17 conceptual schema storing unit
18 background knowledge information storing unit
19 input information storing unit
21 executing unit
22 inverse transforming unit
100 logical formula generation apparatus
101 CPU
102 ROM
103 RAM
104 programs
105 storage device
106 drive device
107 communication interface
108 input/output interface
109 bus
110 storage medium
111 communication network
121 planning means
122 transforming means

What is claimed is:

1. A logical formula generation apparatus comprising:
at least one memory storing instructions; and
at least one processor configured to execute the instructions to:
generate a logical transformation protocol for transforming background knowledge information and input information into logical formulas based on the background knowledge information, the input information, a reasoning schema and a conceptual schema, the background knowledge information representing a reasoning rule, the input information being subjected to a reasoning process by the reasoning rule, the reasoning schema representing a reasoning mode in the reasoning process, the conceptual schema representing a concept handled in the reasoning process; and
transform the background knowledge information and the input information into logical formulas based on the generated logical transformation protocol.

2. The logical formula generation apparatus according to claim 1, wherein the at least one processor is configured to execute the instructions to
generate the logical transformation protocol that defines a transformation rule for transforming components of the background knowledge information and the input information into logical formulas.

3. The logical formula generation apparatus according to claim 2, wherein the at least one processor is configured to execute the instructions to
generate the logical transformation protocol that defines the transformation rule corresponding to a condition satisfied by the background knowledge information, the input information, the reasoning schema, and the conceptual schema.

4. The logical formula generation apparatus according to claim 1, wherein
the background knowledge information and the input information are described in a language of a format set based on the concept represented by the conceptual schema.

5. The logical formula generation apparatus according to claim 1, wherein the at least one processor is configured to execute the instructions to:
execute the logical formula by a reasoning engine based on the reasoning mode represented by the reasoning schema with the logical formula as input for the reasoning engine; and
transform a reasoning result of a logical formula expression obtained by execution of the logical formula, into an expression corresponding to the concept represented by the conceptual schema based on the logical transformation protocol.

6. A logical formula generation method comprising:
generating a logical transformation protocol for transforming background knowledge information and input information into logical formulas based on the background knowledge information, the input information, a reasoning schema and a conceptual schema, the background knowledge information representing a reasoning rule, the input information being subjected to a reasoning process by the reasoning rule, the reasoning schema representing a reasoning mode in the reasoning process, the conceptual schema representing a concept handled in the reasoning process; and
transforming the background knowledge information and the input information into logical formulas based on the generated logical transformation protocol.

7. The logical formula generation method according to claim 6, comprising
generating the logical transformation protocol that defines a transformation rule for transforming components of the background knowledge information and the input information into logical formulas.

8. The logical formula generation method according to claim 7, comprising
generating the logical transformation protocol that defines the transformation rule corresponding to a condition satisfied by the background knowledge information, the input information, the reasoning schema, and the conceptual schema.

9. The logical formula generation method according to claim 6, wherein
the background knowledge information and the input information are described in a language of a format set based on the concept represented by the conceptual schema.

10. The logical formula generation method according to claim 6, comprising:
executing the logical formula by a reasoning engine based on the reasoning mode represented by the reasoning schema with the logical formula as input for the reasoning engine; and
transforming a reasoning result of a logical formula expression obtained by execution of the logical formula, into an expression corresponding to the concept represented by the conceptual schema based on the logical transformation protocol.

11. A non-transitory computer-readable storage medium storing a program comprising instructions for causing a computer to execute processes to:
generate a logical transformation protocol for transforming background knowledge information and input information into logical formulas based on the background knowledge information, the input information, a reasoning schema and a conceptual schema, the background knowledge information representing a reasoning rule, the input information being subjected to a reasoning process by the reasoning rule, the reasoning schema representing a reasoning mode in the reasoning process, the conceptual schema representing a concept handled in the reasoning process; and
transform the background knowledge information and the input information into logical formulas based on the generated logical transformation protocol.
